(19) United States
(12) Patent Application Publication
(10) Pub. No.: US 2014/0078911 A1
(43) Pub. Date: Mar. 20, 2014

(54) METHOD AND APPARATUS TO DETERMINE THE AMOUNT OF DELAY IN ROUND TRIP LATENCY FOR A CONNECTION WHERE THE TCP TRAFFIC DOES NOT CONTAIN MULTI-PACKET RESPONSES OR MAY NOT BE TRANSACTION ORIENTED TRAFFIC.

(71) Applicant: FLUKE CORPORATION, Everett, WA (US)

(72) Inventors: Dan Prescott, Elbert, CO (US); Shawn McManus, Colorado Springs, CO (US); Craig Odell, Colorado Springs, CO (US)

(73) Assignee: FLUKE CORPORATION, Everett, WA (US)

(21) Appl. No.: 13/621,637

(22) Filed: Sep. 17, 2012

(51) Int. Cl. H04L 12/26

(52) U.S. Cl. CPC H04L 43/0864
USPC 370/252

(57) ABSTRACT

A network round trip time measurement apparatus and method employ request/response timing to determine network round trip time. An initial network round trip value is determined, and subsequent network round trip values are determined for possible better measurement values. Response send time and subsequent next request receipt times are employed to determine network round trip values, as well as response and ack packet times.

### BACKGROUND OF THE INVENTION

This invention relates to network test and measurement, and more particularly to determination of delay in round trip latency.

The ability to correctly measure Network Response Time (NRT) under atypical conditions is desirable. Such atypical conditions include: TCP traffic that does not contain multi-packet responses (i.e. multiple data packets followed by acknowledgment does not need to be present), and TCP traffic that carries protocols for which each request queues off of a response. If TCP traffic does not contain the conventionally necessary sequence of packets needed to measure NRT, current technology does not provide an adequate NRT measurement.

### SUMMARY OF THE INVENTION

In accordance with the disclosure, the ability to correctly measure Network Response Time (NRT) under atypical conditions is provided. Methods and apparatus to determine the amount of delay in round trip latency for a connection where the TCP traffic does not contain multi-packet responses or may not be transaction oriented traffic is provided.

Accordingly, it is an advantage of the present disclosure to provide an improved network round trip measurement method and apparatus.

It is a further advantage of the present disclosure to provide an improved network round trip measurement that takes advantage of multiple measurements to determine an optimal value.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a flow diagram illustrating using response to a request/ack to achieve NRT measurement;

FIG. 2 is a flow diagram illustrating use of an ‘invalid’ measurement technique to potentially obtain a better measurement value;

FIG. 3 is a flow diagram illustrating a statistical view of the network round trip measurements;

FIG. 4 is a flow diagram that illustrates the NRT measurement used with streaming protocols; and

FIG. 5 is a block diagram of a network test instrument embodying the methods and apparatus.

### DETAILED DESCRIPTION

The system according to a preferred embodiment of the present invention comprises method and apparatus to correctly measure Network Response Time (NRT) under atypical conditions, including TCP traffic that does not contain multi-packet responses (i.e. multiple data packets followed by acknowledgment does not need to be present), and TCP traffic that carries protocols for which each request queues off of a response. The problem solved is that of if TCP traffic does not contain the conventionally necessary sequence of packets needed to measure NRT; it is possible, using this method or apparatus, to achieve an NRT measurement.

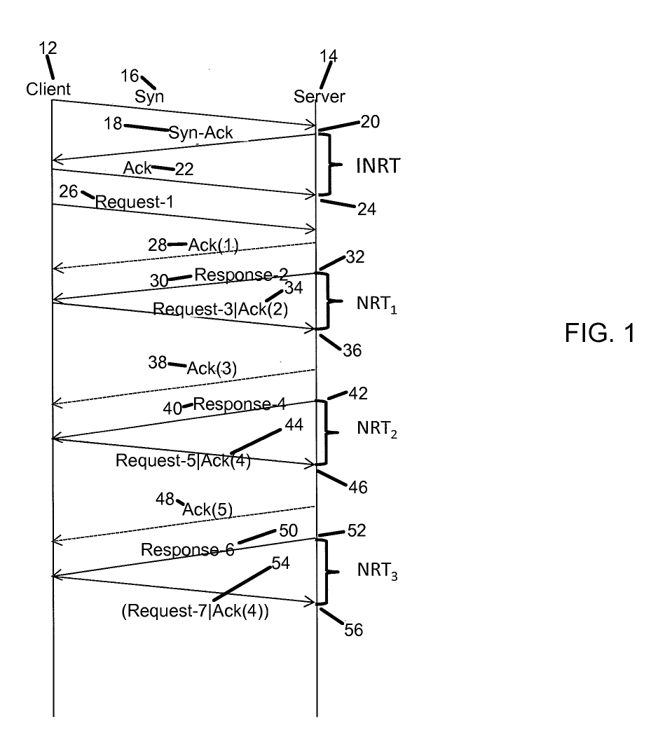

Referring to FIG. 1, a flow diagram illustrating using response to a request/ack to achieve NRT measurement, client 12 and server 14 are in communication via a network. Client 12 sends Syn 16 to server 14 to begin communication, whereupon server 14 response with Syn-ack 18, beginning the initial network round trip measurement (INRT) at time 20. Upon receipt of Ack 22 from client 12 at time 24, the initial round trip time is calculated as time 24 minus time 20. Next client 12 sends Request-1 26, which is acknowledged by server 16 at 28, followed by transmission of response-2 at 30 from the server at time 32, beginning the measurement of time NRT1. On receipt of request-3/Ack(2) 34 from the client at time 36, NRT1 is calculated as the difference between time 32 and 36.

At 38 the server sends Ack(3), followed by response-4 40 at time 42, acknowledged by client 12 with request-5/Ack(4) at 44, received at server 14 at time 46, allowing calculation of NRT2 as time 46 minus time 42. Server 16 then sends Ack(5) 48, followed by response-6 50 sent at time 52, and upon receipt of Request-7/Ack(4) 54 from the client at time 56, NRT3 can be calculated as time 56 minus time 52.

In the above example, which is suitably used for protocol-basis non-concurrent (transaction based) protocols, the client requests, request-3, request-5 and request-7 are triggered by receiving a response from the server, and the time between the server response and the next client request represents NRT (plus any negligible client-side processing time).

So,

NRT=Time_{Request(x+10|Ack(X)}−Time_{ResponseX}

That is, NRT is the time between a response, X, and the next conjunctive request-acknowledgment where the acknowledgment is acknowledging the server response, X.

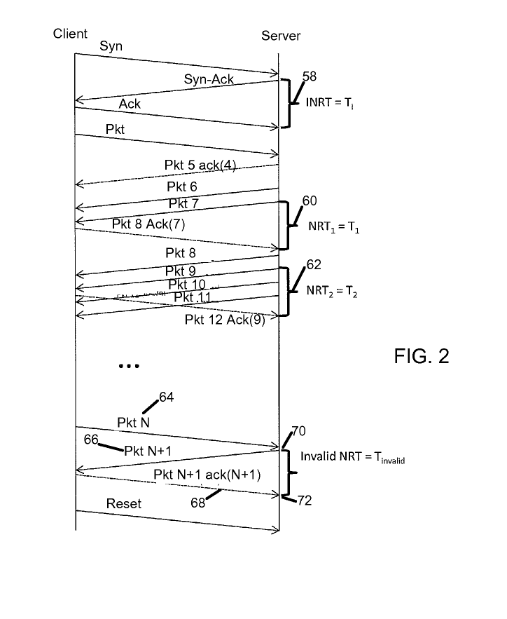

Referring now to FIG. 2, a flow diagram illustrating use of an ‘invalid’ measurement technique to potentially obtain a better measurement value, initial round trip time and subsequent round trip time values are determined much as in the example of FIG. 1, with the initial NRT measurement taken as the time between the server Syn-Ack and the client response Ack at 58. A valid NRT measurement is taken from two data packets leading to an acknowledgment of those packets, at 60, 62, for example.

This version of FIG. 2, allows for use of ‘invalid’ NRT measurements (i.e. not the double-data>Ack NRT) if and when the invalid measurement provides a smaller NRT than previous NRT measurements. Accordingly, at 64 PktN is sent from the client to the server, and the server responds with packet PktN+1, followed by an ack of packet N+1 by the client (PktN+1 ack (N+1)) at 68. The time between sending of Pkt N+1 by the server at 70 and receipt of the Ack of N+1 at the server at 72 is determined as the Invalid NRT time (which in the illustration, is a smaller time value than the previously determined INRT, NRT₁, NRT₂, etc.).

An invalid NRT measurement is the time between a single data packet and its acknowledgment. However, if the invalid NRT measurement, that comes after INRT or any other NRT measurement, is less than the previous NRT measurements then it is a better metric. So, we can use the invalid NRT measurement if it is less than previous, valid, NRT measurements.

Invalid-NRT=Time_{ack}−Time_{data}//where data is 1 frame

So, the Network Round Trip time is determined as the lesser of an Invalid NRT computation and any previously determined NRT.

NRT=(Invalid-NRT<Previous-NRT)?Invalid-NRT: Previous-NRT

In the diagram of FIG. 2, it is assumed that the Invalid NRT time is less than any of the previously determined NRT values.

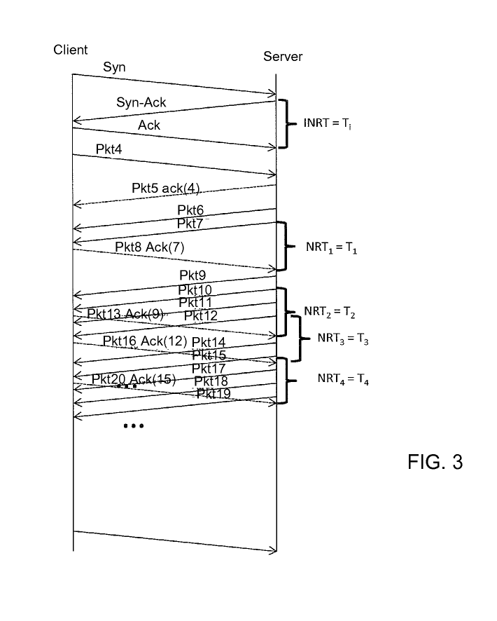

Referring now to FIG. 3, a flow diagram illustrating a statistical view of the network round trip measurements, typically, an NRT measurement is taken from the first NRT available of a transaction. The reasoning behind this is that a user experiences that NRT most noticeably. However, some transactions can last extended periods of time and NRT can change within that time period. Accordingly, the current methods/apparatus invention allow for a statistical view of the NRT measurements. Referring to FIG. 3, the initial NRT, INRT is determined, and subsequent NRT values NRT₁, NRT₂, NRT₃, NRT₄, etc. are determined, and averaging, average of minimums, minimum values or other statistical values based on the multiple determined values can be employed.

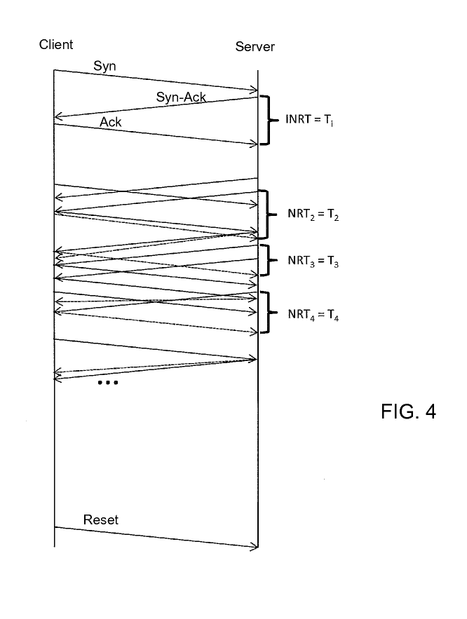

FIG. 4 illustrates the NRT measurement used with streaming protocols, wherein stream based protocols provide a less uniform flow, as there is not a defined relationship between client data packets and server data packets. Despite being stream-based, it is still possible to make the NRT measurements on stream based protocols using methods corresponding to those previously used, wherein two data packets->Ack provides NRT. In FIG. 4, the Syn/Syn-Ack/Ack exchange provides initial NRT (INRT) as the time between the Syn-Ack being sent and the receipt of the Ack at the server. Subsequent NRT values, NRT₂, NRT₃, NRT₄, etc. are determined as the time between sending of a packet by the server and the Ack of that packet.

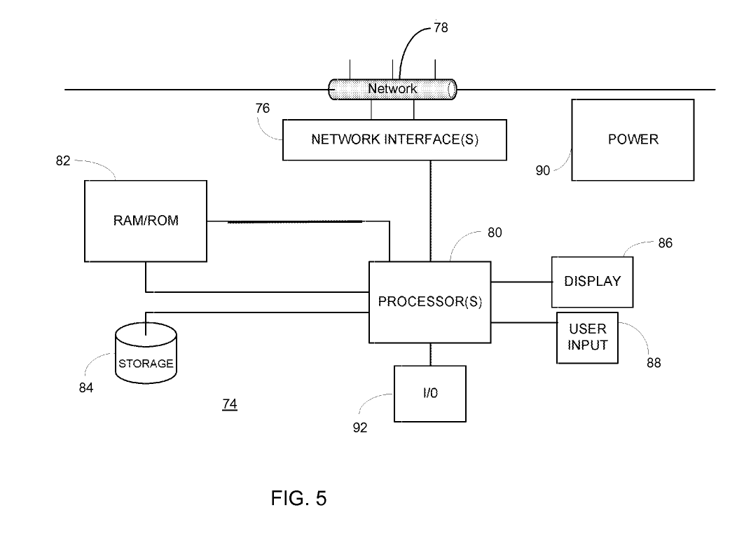

FIG. 5 is a block diagram of a network test instrument 74 implementing the methods and apparatus, wherein the instrument may include network interfaces 76 which attach the device to a network 78 via multiple ports, one or more processors 80 for operating the instrument, memory such as RAM/ROM 82 or persistent storage 84, display 86, user input devices 88 (such as, for example, keyboard, mouse or other pointing devices, touch screen, etc.), power supply 90 which may include battery or AC power supplies, other interface 92 which attaches the device to a network or other external devices (storage, other computer, etc.).

In operation, the network test instrument is attached to the network, and observes transmissions on the network to collect data and analyze to determine INRT and NRT values.

While plural embodiments of the technology have been shown and described, it will be apparent to those skilled in the art that many changes and modifications may be made without departing from the broader aspects. The appended claims are therefore intended to cover all such changes and modifications as fall within the true spirit and scope of the technology.

1. A method for determining network round trip transmission time comprising:
measuring a transmission start time for a server transmission;
measuring a receipt time of an acknowledgement of the server transmission; and
determining the network round trip time as the difference between the transmission start time and the receipt time.

2. The method according to claim 1, comprising determining an initial value for the network round trip time based on an initial transmission/acknowledgement, and subsequent network round trip times based on subsequent transmissions/acknowledgments.

3. The method according to claim 2, further comprising selecting the lower value of the initial value and subsequent values as a reported network round trip time value.

4. The method according to claim 2, further comprising employing said initial and subsequent values to make statistical determinations based on the values.

5. The method according to claim 1, wherein said acknowledgment comprises a request for a subsequent server transmission.

6. The method according to claim 1, wherein said transmission and acknowledgment comprise a streaming protocol.

7. Apparatus for determining network round trip time, comprising:
a network interface for receiving transmissions on a network;
a processor for making determinations based on the received transmissions, said determination comprising:
measuring a transmission start time for a server transmission;
measuring a receipt time of an acknowledgement of the server transmission; and
determining the network round trip time as the difference between the transmission start time and the receipt time.

8. The apparatus according to claim 7, further comprising said processor determining an initial value for the network round trip time based on an initial transmission/acknowledgement, and subsequent network round trip times based on subsequent transmissions/acknowledgments.

9. The apparatus according to claim 8, further comprising said processor selecting the lower value of the initial value and subsequent values as a reported network round trip time value.

10. The apparatus according to claim 8, further comprising said processor employing said initial and subsequent values to make statistical determinations based on the values.

11. The apparatus according to claim 7, wherein said acknowledgment comprises a request for a subsequent server transmission.

12. The apparatus according to claim 7, wherein said transmission and acknowledgment comprise a streaming protocol.
